(19) United States
(12) Patent Application Publication
(10) Pub. No.: US 2023/0038713 A1
(43) Pub. Date: Feb. 9, 2023

(54) ROTOR ASSEMBLIES

(71) Applicant: GHSP, Inc., Holland, MI (US)

(72) Inventors: David Michael Mitteer, Shelby, MI (US); Nathaniel Joseph McMackin, New Era, MI (US); Bradley John Vecellio, Spring Lake, MI (US); Jian Peng He, Grand Haven, MI (US)

(21) Appl. No.: 17/790,190

(22) PCT Filed: Jan. 14, 2021
(86) PCT No.: PCT/IB2021/050261

§ 371 Date: Jun. 30, 2022

Related U.S. Application Data
(60) Provisional application No. 62/960,887, filed on Jan. 14, 2020.

(51) Int. Cl. H02K 15/03; H02K 1/278

(52) U.S. Cl. CPC H02K 15/03; H02K 1/278

(57) ABSTRACT

A rotor assembly for use with a stator is disclosed. The rotor assembly includes a shaft that defines at least one outer diameter. The rotor assembly also includes a body that defines at least one interior diameter. The shaft is received within the at least one interior diameter of the body. The body is provided with a magnetic field with alternating polar arrangements as a function of a circumferential position about a circumference of the body.

### FIELD OF THE DISCLOSURE

The present disclosure generally relates to rotor-stator assemblies. More specifically, the present disclosure relates to rotor assemblies for the same.

### BACKGROUND OF THE INVENTION

Motors, pumps, and various other assemblies have employed rotor-stator assemblies in a variety of environments and applications. Additional rotor-stator assemblies are needed that build upon and/or enhance the capabilities of the motors, pumps, and various other assemblies that employ rotor-stator assemblies.

### SUMMARY OF THE INVENTION

According to a first aspect of the present disclosure, a rotor assembly for use with a stator includes a shaft and a body. The shaft defines at least one outer diameter. The body defines at least one interior diameter. The shaft is received within the at least one interior diameter of the body. The body is provided with a magnetic field with alternating polar arrangements as a function of a circumferential position about a circumference of the body. The body is made of a polymeric material and the polymeric material includes magnetic particles. An exterior surface of the body is continuous such that a boundary between adjacent magnetic sections of the body are imperceptible to a human eye.

According to various examples of the first aspect, the body can be overmolded upon the shaft. In some examples, the body is produced in a monolithic form such that the body encapsulates the shaft. In various examples, the magnetic particles can include bonded neodymium iron boron. In some examples, the magnetic particles can be magnetic polymer particles. The magnetic particles can be utilized to impose magnetic poles to the body.

According to a second aspect of the present disclosure, a rotor assembly for use with a stator includes a shaft and a body. The shaft defines at least one outer diameter. The body includes at least one interior diameter defined by the body. The shaft is received within the at least one interior diameter of the body. The body is made from a polymeric material. The polymeric material includes magnetic particles. The body also includes a plurality of first protrusions and a plurality of second protrusions. One of The plurality of second protrusions is positioned between adjacent ones of the plurality of first protrusions. The first and second protrusions define recesses therebetween.

According to various examples of the second aspect, the rotor assembly can include a plurality of magnetic portions, with each of the recesses receiving one of the plurality of magnetic portions. In some examples, the body may be provided with a magnetic field with alternating polar arrangements as a function of a circumferential position about a circumference of the body. In various examples, the magnetic portions may be sintered neodymium magnets.

According to a third aspect of the present disclosure, a tooling arrangement includes a first portion, a second portion, and a variable member. The first and second portions define an inner diameter. The first portion, the second portion, and the variable member define a forming cavity. The variable member is movable with respect to the first portion and the second portion such that a volume of the forming cavity is adjustable. The forming cavity is configured to receive a magnetic material.

According to various examples of the third aspect, the forming cavity can receive a polymeric material. The polymeric material can define at least a portion of a body of a rotor assembly. The volume of the forming cavity can be adjusted by altering a position of the variable member with respect to the first and second portions. The position of the variable member can correlate to a length dimension of the body of the rotor assembly. The inner diameter of the first and second portions can be maintained as a constant dimension as the position of the variable member is adjusted. In various examples, the polymeric material can include magnetic particles. In some examples, the tooling arrangement includes a coil that is configured to orient magnetic poles of the body of the rotor assembly. In various examples, the tooling arrangement can include pocket-forming inserts that are utilized to form recesses in the body. The recesses may each receive a magnetic portion after removal of the pocket-forming inserts.

According to a fourth aspect of the present disclosure, a method for manufacturing a rotor assembly includes the steps of selecting a shaft; adjusting a position of a variable member such that a volume of a forming cavity of a tooling arrangement is altered based upon a length of the selected shaft; positioning the selected shaft within the forming cavity; injecting a polymeric material into the forming cavity after the step of positioning the selected shaft within the forming cavity, the polymeric material at least partially defining a rotor body, the rotor body and the selected shaft defining a magnetically-susceptible rotor body; and magnetizing the magnetically-susceptible rotor body to orient magnetic poles of the magnetically-susceptible rotor body.

According to various examples of the fourth aspect, the polymeric material can include magnetic particles. In some examples, the step of magnetizing the magnetically-susceptible rotor body is executed while the magnetically-susceptible rotor body is within the forming cavity of the tooling arrangement. In various examples, the tooling arrangement includes a coil that is employed in the step of magnetizing the magnetically-susceptible rotor body. The method can also include the steps of positioning a pocket-forming insert within the forming cavity; and forming recesses in the body of the rotor assembly. In some examples, the step of magnetizing the magnetically-susceptible rotor body includes inserting magnetic portions into the recesses formed by the pocket-forming inserts. In various examples, the step of magnetizing the magnetically-susceptible rotor body is executed such that the magnetically-susceptible rotor body is provided with a magnetic field with alternating polar arrangements as a function of a circumferential position about a circumference of the magnetically-susceptible rotor body.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a front perspective view of various exemplary aspects of rotor assemblies (a)-(i) of the present disclosure;

FIG. 2 is a front view of the various exemplary aspects of the rotor assemblies of FIG. 1;

FIG. 3A is a front perspective view of rotor assemblies with homogenous bodies, according to one example;

FIG. 3B is a front perspective wire frame view of the rotor assemblies of FIG. 3A;

FIG. 4A is a front perspective view of a shaft of the rotor assembly, according to one example;

FIG. 4B is a front perspective view of the shaft of the rotor assembly, similar to FIG. 4A, according to one example;

FIG. 4C is a front perspective wire frame view of the shaft of the rotor assembly, according to one example;

FIG. 5A is a top perspective view of the body of the rotor assembly, according to one example;

FIG. 5B is a top perspective wire frame view of the body of the rotor assembly, according to one example;

FIG. 6 is a top perspective view of a series of exemplary rotor bodies (g)-(i) of rotor assemblies where the rotor bodies are segmented bodies, according to one example;

FIG. 7A is a top perspective view of the segmented body of the rotor assembly with magnetic portions removed from the segmented body, according to one example;

FIG. 7B is a top view of the segmented body of the rotor assembly with the magnetic portions removed, according to one example;

FIG. 8A is a front perspective view of magnetic portions of the segmented body in isolation, according to one example;

FIG. 8B is a top view of magnetic portions of exemplary rotor bodies (a)-(c) having the segmented body, according to one example;

FIG. 9 is a plot of magnetic field, in Teslas, versus angular displacement, in degrees, about a circumference of various examples of the rotor assemblies of the present disclosure;

FIG. 10A is a magnetic field plot of a rotor assembly that includes a polymer non-magnetic cage, according to one example;

FIG. 10B is a magnetic field plot of a rotor assembly that includes a bonded ferrite magnetic cage, according to one example;

FIG. 11 is a flow diagram depicting a method of manufacturing a rotor assembly, according to one example; and

FIG. 12 is a schematic representation of a cross-section of a tooling arrangement of the present disclosure, illustrating a first portion, a second portion, and a variable member, according to one example.

### DETAILED DESCRIPTION OF THE PREFERRED EMBODIMENTS

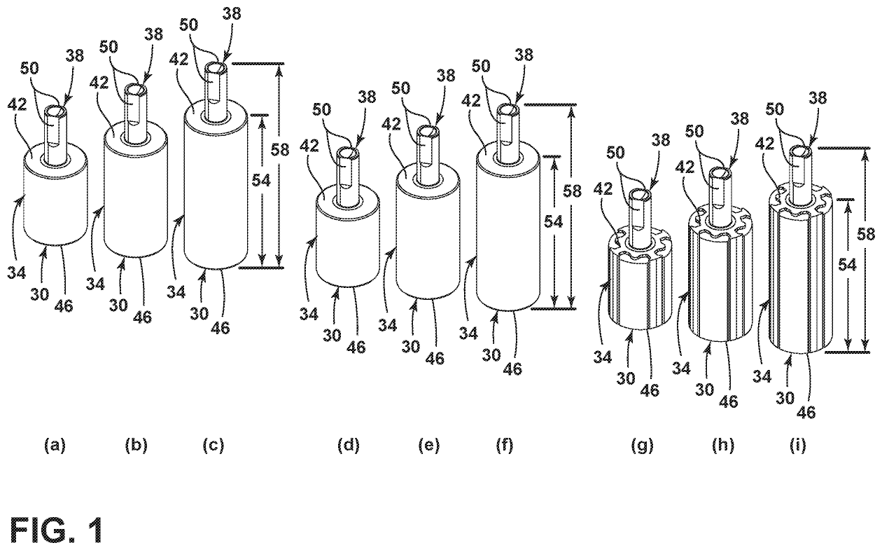

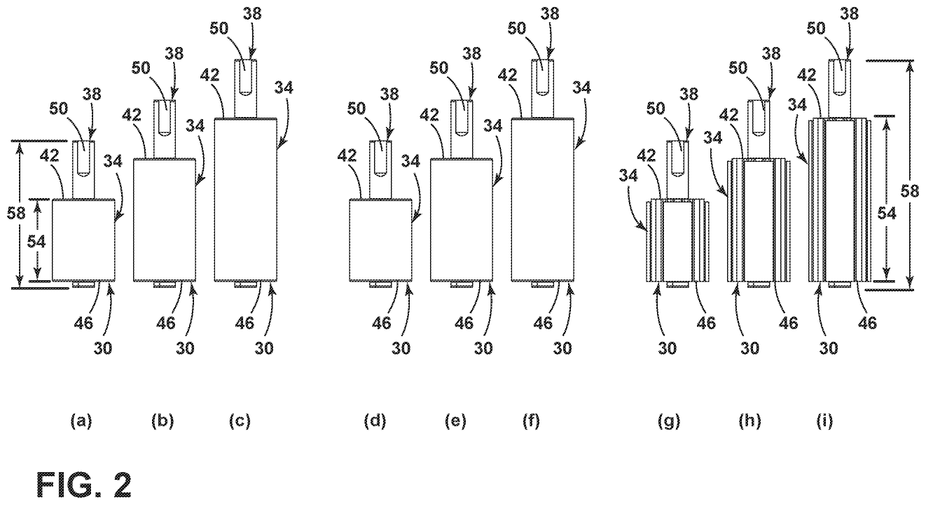

For purposes of description herein, the terms “upper,” “lower,” “right,” “left,” “rear,” “front,” “vertical,” “horizontal,” and derivatives thereof shall relate to the concepts as oriented in FIGS. 1 and 2. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to rotor-stator assemblies. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

The present disclosure generally relates to rotor-stator assemblies. More specifically, the present disclosure relates to rotor constructions for use in rotor-stator assemblies. The rotor-stator assembly is a rotary system that includes a stator (not shown) and a rotor assembly 30. The stator remains stationary during operation of the rotor-stator assembly. The stator includes a plurality of windings, through which electrical energy is transmitted. The rotor assembly 30 rotates relative to the stator. The rotor assembly 30 includes a plurality of magnets (e.g., magnetic portions 174) or a plurality of sections that are magnetically-susceptible. Transmission of electrical energy through the windings of the stator induces a magnetic field that induces rotation of the rotor assembly 30 as a result of the magnets or sections of magnetically-susceptible material endeavoring to align their magnetic poles with the magnetic field provided by the stator, in a manner that is understood by one of skill in the art. The windings of the stator are energized in a systematic manner to induce a desired degree of rotation of the rotor assembly 30 (e.g., intermittent rotation or continuous rotation).

With reference to FIGS. 1 and 2, a variety of rotor assemblies 30 are depicted. The rotor assembly 30 includes a body 34 and a shaft 38. The shaft 38 extends through the body 34 in a coaxial manner such that the body 34 and the shaft 38 form concentric circles relative to one another. In various examples, the shaft 38 extends beyond a top surface 42 and/or a bottom surface 46 of the body 34. The shaft 38 may be cylindrical, triangular, rectangular, and/or any other polygon that is suitable for a given application. In examples where the shaft 38 is cylindrical, the shaft 38 may be provided with one or more faces 50 that are flattened, protruded, or otherwise shaped to provide a bearing surface that may be utilized for coupling the shaft 38 to a component that is to be driven by the rotation of the shaft 38 relative to the stator. In the depicted examples, the faces 50 that are flattened on the shaft 38 are provided on a portion of the shaft 38 that extends beyond the top surface 42 of the body 34. A length 54 of the body 34 and a length 58 of the shaft 38 may be adjusted or varied to suit a particular application without departing from the concepts disclosed herein. In some examples, an outer diameter of the body 34 and/or an outer diameter of the shaft 38 may remain constant while the length 54 of the body 34 and/or the length 58 of the shaft 38 are varied.

It is contemplated that the outer diameter of the shaft 38 may be at least partially dictated by an amount of torque that the shaft 38 is anticipated to experience in its intended application or environment. In various examples, dimensions of the stator may also be varied based on an intended application or use for the rotor-stator assembly. The scale, dimensions, and/or proportions of the body 34 and the shaft 38 may be varied relative to one another without departing from the concepts disclosed herein.

Accordingly, the scale, dimensions, and/or proportions of the rotor assembly 30 may be adjusted to suit particular environmental constraints and/or requirements of a given application. While the present disclosure is not to be limited to any particular application or use of the rotor assemblies 30 disclosed herein, the rotor assemblies 30 may be utilized in rotary controls, electrical motors, pumps, or any other environment where rotor-stator configurations are employed.

Referring again to FIGS. 1 and 2, various examples of the rotor assembly 30 are depicted in a series of three sizes in an effort to show some aspects of the scalability or variability capable with the rotor assemblies 30 of the present disclosure. As discussed above, additional or alternative variations in scale, dimensions, and/or proportion of the various components and elements of each component of the rotor assembly 30 may be adjusted to suit particular applications and/or use. The series of three rotor assemblies 30 on the left ((a)-(c)) and in the middle ((d)-(f)) of FIGS. 1 and 2 may be referred to as homogeneous body examples, where the body 34 of the rotor assembly 30 is provided with a continuous circumference with a constant radius from a centerline of the body 34. Said another way, the homogeneous body presents a smooth exterior about its circumference such that there is no perceptible segregation between adjacent magnetic sections of the body 34, as will be discussed further herein. Referencing the adjacent magnetic sections of the body 34 in the homogeneous body examples as “sections” is not intended to imply physical separation or perceptible delineation of the adjacent magnetic sections. Rather, the term “sections” is intended to refer to regions of the body 34 that have a magnetic polarity that is oriented in a given direction, with the given direction of magnetic polarity differing from a direction of magnetic polarity of immediately adjacent sections or regions of the body 34. Accordingly, the entirety of the circumference of the body 34 in the homogeneous body examples is magnetically active, with the sections or regions of magnetism being defined by the orientation of their respective magnetic fields. While the homogeneous body examples are referred to as having no perceptible segregation between adjacent magnetic sections of the body 34, one of skill in the art will recognize that such imperceptible segregation between adjacent magnetic sections of the body 34 is not intended to imply there exists no way of interrogating or differentiating the adjacent magnetic sections. Rather, referring to the homogeneous body examples as having no perceptible segregation between adjacent magnetic sections of the body 34 is intended to refer to observation of a surface of the exterior circumference of the body 34 by a human eye or by physically touching the exterior circumference of the homogeneous body.

For example, it may be possible to elucidate the magnetic sections, the orientation of the magnetic sections (e.g., orientation of the poles of the magnetic sections), and/or boundaries between adjacent magnetic sections by measuring or otherwise testing the magnetic field of the body 34 as a function of circumferential position.

The series of three rotor assemblies 30 on the right ((g)-(i)) of FIGS. 1 and 2 may be referred to as segmented body examples, where the body 34 of the rotor assembly 30 is provided with protrusions that define recesses and the recesses receive magnetic sections or portions, as will be discussed further herein. Adjacent magnetic sections of the body 34 of the segmented body examples may be perceived by a human eye and/or by physically touching the exterior surface of the body 34.

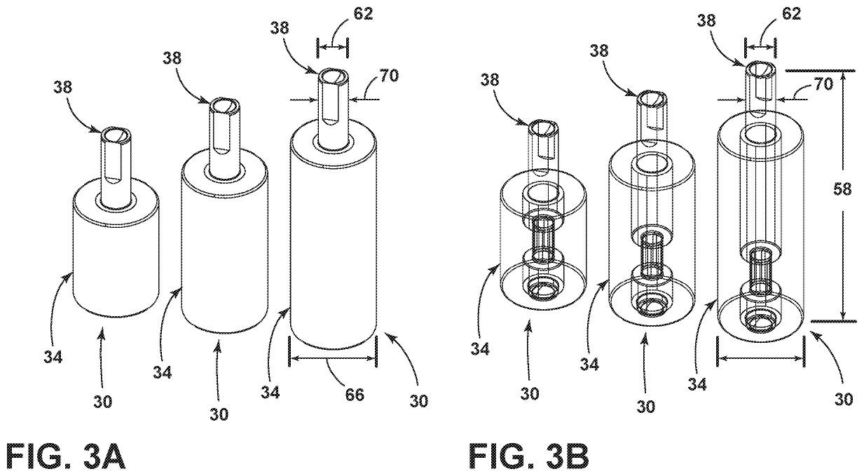

Referring now to FIGS. 3A and 3B, examples of the homogeneous body rotor assemblies 30 are shown. The body 34 defines an inner diameter 62 and an outer diameter 66. The inner diameter 62 of the body 34 generally corresponds with an outer diameter 70 of the shaft 38. The outer diameter 70 of the shaft 38 can vary along the length 58 of the shaft 38. Accordingly, the shaft 38 may be defined by a plurality of outer diameters 70, as will be discussed in further detail herein. Similarly, the body 34 may be provided with a plurality of inner diameters 62 that correspond to the plurality of outer diameters 70 of the shaft 38 in number, dimension, and/or position, as will be discussed in further detail herein.

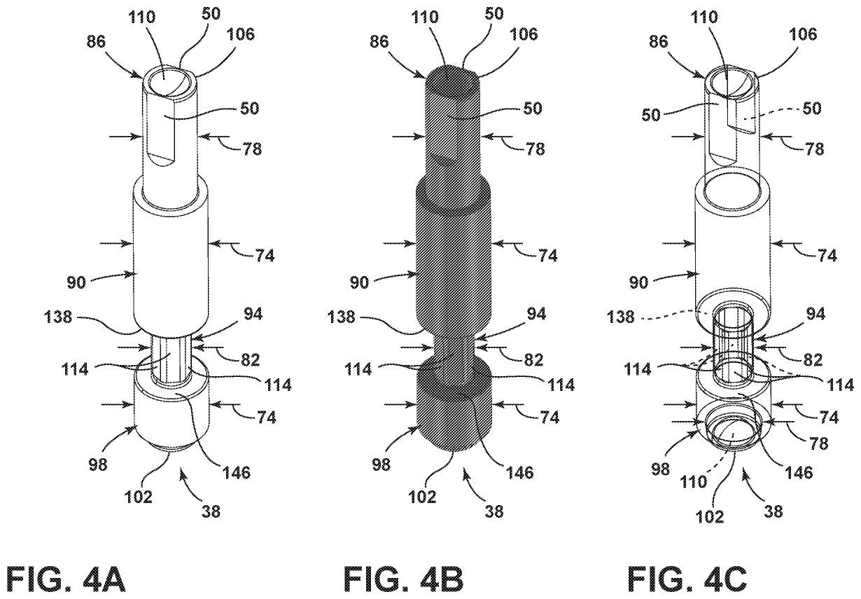

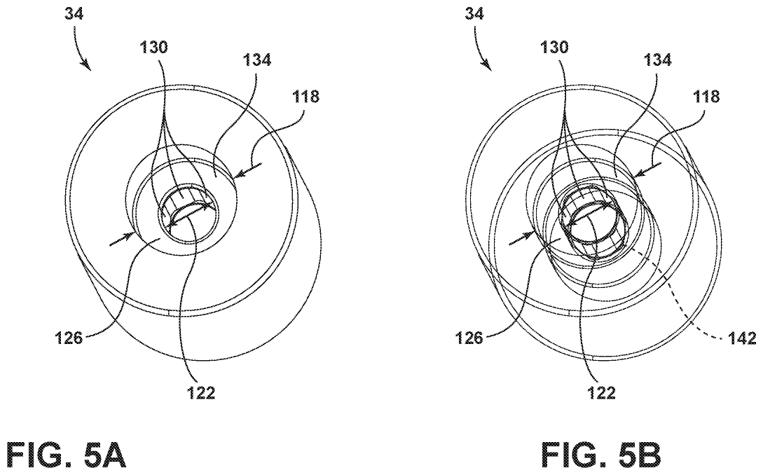

Referring to FIGS. 4A-5B, the shaft 38 can include a plurality of outer diameters 70. For example, the shaft 38 can include a first outer diameter 74, a second outer diameter 78, and a third outer diameter 82. In various examples, the first outer diameter 74 may be the greatest of the plurality of outer diameters of the shaft 38. The third outer diameter 82 of the shaft 38 may be the smallest of the plurality of outer diameters of the shaft 38. The second outer diameter 78 may be dimensioned as an intermediate value that is between the sizes of the first and third outer diameters 74, 82 of the shaft 38. The first outer diameter 74, the second outer diameter 78, and/or the third outer diameter 82 may be positioned at multiple locations along the length 58 of the shaft 38 such that segments of the first, second, and/or third outer diameters 74, 78, 82 may be separated by others of the first, second, and/or third outer diameters 74, 78, 82.

For example, as depicted in FIGS. 4A-4C, an upper end 86 of the shaft 38 may be provided with the second outer diameter 78, with an upper central portion 90 that is immediately adjacent to the upper end 86 being provided with the first outer diameter 74. A middle central portion 94 of the shaft 38 can be provided with the third outer diameter 82, with the middle central portion 94 being immediately adjacent to the upper central portion 90 and distal to the upper end 86. A lower central portion 98 can be provided with the first outer diameter 74 and immediately adjacent to the middle central portion 94 and distal to the upper central portion 90. In various examples, the shaft 38 may include a lower end 102 that extends beyond the lower central portion 98, with the lower end 102 being distal to the middle central portion 94. The upper and lower ends 86, 102 are opposing ends of the shaft 38. Terminal ends 106 of the upper end 86 and/or the lower end 102 may be provided with a recessed portion 110. The recessed portion 110 extends inwardly from the terminal end 106 such that the recessed portion 110 is concave relative to the terminal end 106. The recessed portions 110 may aid in retaining and/or positioning the shaft 38 during manufacture, assembly, and/or operation of the rotor-stator assemblies.

Referring again to FIGS. 4A-5B, the middle central portion 94 of the shaft 38 can be provided with one or more faces 114. The faces 114 may be flattened regions positioned about the circumference of the middle central portion 94. The faces 114 may serve a similar purpose to the faces 50 that are positioned on the upper end 86 of the shaft 38. The faces 50 provide a bearing surface that may be utilized for coupling the shaft 38 to a component that is to be driven by the rotation of the shaft 38 relative to the stator. Whereas, the faces 114 may be configured to engage with an interior portion of the body 34 to retain a rotational position of the body 34 relative to the shaft 38 and vice versa. Said another way, the faces 114 of the shaft 38 engage with the body 34 in a manner that prevents the body 34 from rotating about the shaft 38 while the shaft 38 remains stationary. Similarly, the faces 114 of the shaft 38 engage with the body 34 in a manner that prevents the body 34 and the shaft 38 from rotating at different speeds relative to one another. Accordingly, the faces 114 may provide a rotational lock between the body 34 and the shaft 38 by engaging with corresponding structures on the body 34, which can be seen in FIGS. 5A-5B and will be discussed further herein. Therefore, the faces 50 and the faces 114 can each provide a rotational lock, or transmission of motion, to the components with which the faces 50, 114 engage.

For example, the faces 50 rotationally lock with the component that is to be driven by the rotation of the rotor assembly 30 relative to the stator. Similarly, the faces 114 of the shaft 38 engage with the corresponding structure on the body 34 such that the body 34 and the shaft 38 are rotationally locked. Therefore, rotational motion that is imparted to the body 34 by the systematic energizing of the windings of the stator as a result of the magnetic properties of the body 34 is translated into rotational motion of the shaft 38 by way of the rotational lock between the body 34 and the shaft 38. The rotational motion of the shaft 38 is then translated into rotational motion of the component that is to be driven by the rotor assembly 30 by way of the rotational lock, provided by the faces 50, between the component to be driven and the shaft 38.

Referring further to FIGS. 4A-5B, the body 34 of the rotor assembly 30 can be provided with a plurality of inner diameters. For example, the body 34 can include a first inner diameter 118 and a second inner diameter 122. The second inner diameter 122 can be less than the first inner diameter 118. Accordingly, the difference between the first and second inner diameters 118, 122 may provide a flange 126 that can aid in positioning the body 34 relative to the shaft 38 along the length directions of the body 34 and shaft 38. The second inner diameter 122 of the body 34 can be provided with faces 130 that are flattened to provide a bearing surface that may be utilized for coupling the body 34 to the shaft 38. For example, the faces 130 of the body 34 can engage with the faces 114 on the middle central portion 94 of the shaft 38 to retain a rotational position of the body 34 relative to the shaft 38 and vice versa. Accordingly, the engagement between the faces 114 of the shaft 38 and the faces 130 of the body 34 prevent the body 34 and the shaft 38 from rotating at different speeds and enable a transferring of the rotational motion of the body 34, as initiated by the stator, into rotational motion of the shaft 38. The flange 126 that is defined by the difference between the first and second inner diameters 118, 122 of the body 34 is positioned between the upper central portion 90 and the lower central portion 98 of the shaft 38. The second inner diameter 122 is less than the first outer diameter 74 of the shaft 38. Accordingly, with the shaft 38 being provided with the first outer diameter 74 at the upper central portion 90 and the lower central portion 98 and the flange 126 of the body 34 being positioned between the upper central portion 90 and the lower central portion 98, the body 34 is maintained in a longitudinal position (i.e., along the length directions of the body 34 and the shaft 38) relative to the shaft 38 by a physical impediment provided by an interference or engagement between an upper surface 134 of the flange 126 and a lower surface 138 of the upper central portion 90, as well as an interference or engagement between a lower surface 142 of the flange 126 and an upper surface 146 of the lower central portion 98.

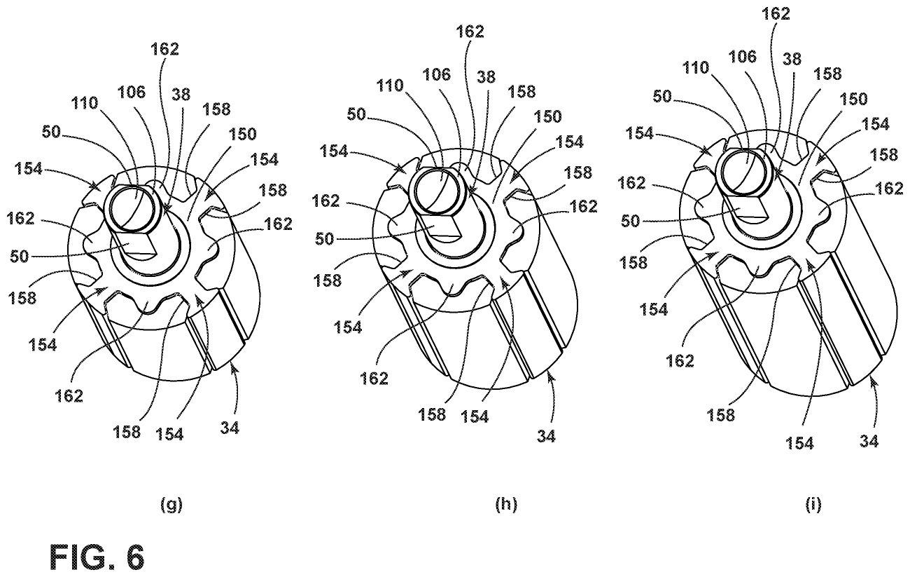

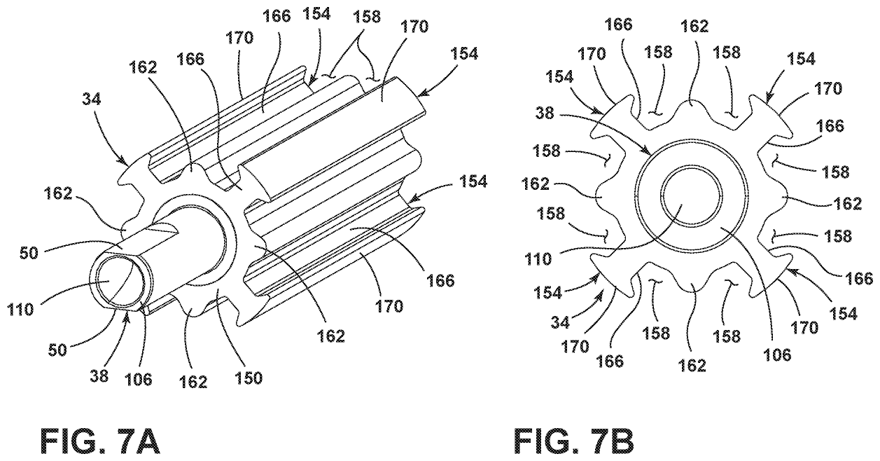

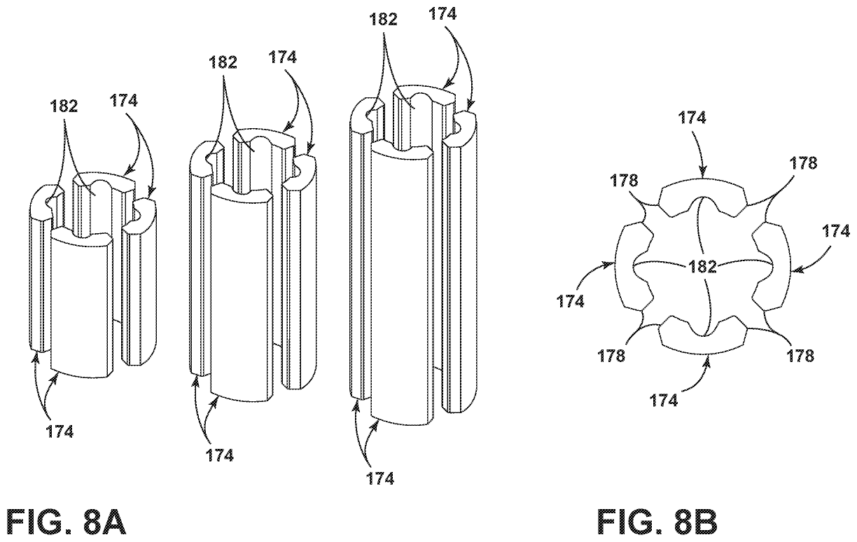

Referring to FIGS. 6-8B, examples of the segmented body of the rotor assembly 30 are shown. The shaft 38 includes the faces 50 and the recessed portions 110 in the terminal ends 106. In the depicted examples of the segmented body, the body 34 includes a core portion 150. A plurality of first protrusions 154 extend radially outward from the core portion 150 to define recesses 158 between adjacent protrusions 154. In various examples, a plurality of second protrusions 162 extend radially outward from the core portion 150, with one of the second protrusions 162 being positioned between each adjacent first protrusion 154 such that the first and second protrusions 154, 162 alternate about a circumference of the core portion 150. In various examples, the second protrusions 162 may extend radially outward from the core portion 150 to a lesser extent than the first protrusions 154. The first protrusions 154 include a post 166 and a head 170. The second protrusions 162 may be generally parabolic in shape. In some examples, the second protrusions 162 may extend from core portion 150 along an entirety of the length 54 of the body 34. In various examples, the second protrusions 162 may be positioned at one end of the core portion 150 and thereby retain the magnetic portions 174 in a direction (e.g., upward) that is parallel to the length 54 of the body 34.

Referring again to FIGS. 6-8B, the head 170 of each of the first protrusions 154 extends radially outward from a centerline of the corresponding post 166 such that the head 170 is provided with a width that is greater than a width of the post 166 in a cross-sectional direction. Accordingly, the post 166 and the head 170 can aid in retaining magnetic portions 174 in a radial direction by forming a portion of the recess 158 between an interior surface of the head 170 and an exterior surface of the core portion 150 of the body 34. The magnetic portions 174 can be inserted into each of the recesses 158 that are provided in the body 34. The magnetic portions 174 are provided with a shape that corresponds to the recesses 158 defined by the core portion 150, the first protrusions 154, and the second protrusions 162. The magnetic portions 174 are generally arcuate in shape and often correspond with the contours of the core portion 150 and/or the second protrusions 162 of the body 34. Lateral ends 178 of the magnetic portions 174 are tapered to engage with the post 160 and the head 170 of the first protrusions 154 on either side of the recesses 158. In examples where the second protrusions 162 extend along an entirety of the length 54 of the body 34, the magnetic portions 174 can include a notch 182 that corresponds with the second protrusion 162.

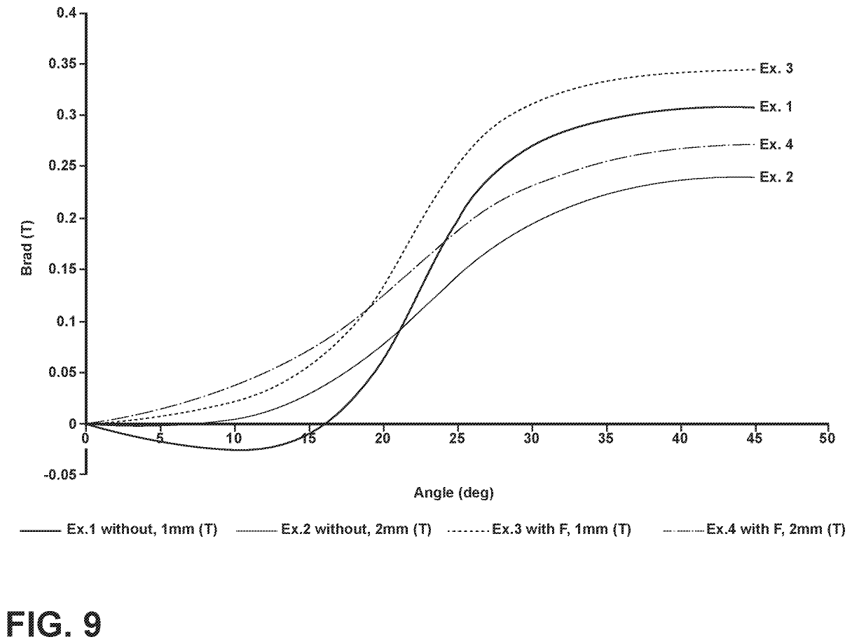

Referring now to FIG. 9, various examples of the rotor assembly 30 are shown in a plot of magnetic field, in Teslas, versus radial displacement, in degrees, about a circumference of the rotor assembly 30. The body 34 of the rotor assembly 30 can be injection molded in both the homogeneous body examples and the segmented body examples. In the segmented body examples, the core portion 150, the first protrusions 154, and the second protrusions 162 may be injection molded while the magnetic portions 174 are separately formed and inserted into the recesses 158 during assembly. The shaft 38 may also be injection molded and may also be formed from other metal-forming processes.

In FIG. 9, Example 1 (Ex. 1, solid-bold line) and Example 2 (Ex. 2, solid line) represent bodies 34 of the rotor assembly 30 that were made from a non-magnetic polymer (e.g., without ferrite) that hold the magnetic portions 174. The body 34 of Example 1 was made with a polymer thickness of about 1 mm. The body 34 of Example 2 was made with a polymer thickness of about 2 mm. As can be seen in FIG. 9, increasing the thickness of the polymer in the absence of a magnetic material, such as ferrite, being provided within the polymer decreased a change in magnetic field of the rotor assembly 30 as a function of radial displacement about the circumference of the body 34.

In FIG. 9, Example 3 (Ex. 3, dashed line) and Example 4 (Ex. 4, dashed-dot line) represent bodies 34 that were made of an injection moldable magnetic material, such as bonded ferrite. The body 34 of Example 3 was made with a magnetic material thickness of 1 mm. The body 34 of Example 4 was made with a magnetic material thickness of 2 mm. As can be seen in FIG. 9, increasing the thickness of the magnetic material decreased a change in magnetic field of the body 34 as a function of radial displacement about the circumference of the body 34, similar to Examples 1 and 2. However, the presence of the magnetic material in the body 34 of Examples 3 and 4, using the bonded ferrite, resulted in a tempering of the shape of the magnetic field as a function of circumferential position about the body 34. Increasing the thickness of the polymer similarly tempered the shape of the magnetic field as a function of circumferential position about the body 34. The tempering of the magnetic field as a function of circumferential position about the body 34 is evidenced by the decreased contour of the generally serpentine shape of the lines associated with Examples 1-4 with Example 1 being the most contoured and Example 4 being the least contoured.

In FIG. 9, comparing Examples 1 and 3, where the difference between these examples is the absence of a magnetic material other than the magnetic portions 174 in Example 1 versus the presence of bonded ferrite in addition to the magnetic portions 174 in Example 3. The presence of the bonded ferrite in Example 3 tempered the shape of the magnetic field as a function of circumferential position about the body 34, similar to increasing the thickness of the polymer when comparing Examples 1 and 2 or increasing the thickness of the magnetic material when comparing Examples 3 and 4. The tempered shape of the plot for Example 3 when compared to Example 1 indicates a more stable magnetic field as a function of circumferential position about the body 34. Additionally, the change in magnetic field from zero degrees(0°) to forty-five degrees)(45° (i.e., a ΔB_{rad}) is greater for Example 3 than for Example 1. The increased ΔB_{rad} may be beneficial in providing a greater amount of torque to the shaft 38 during rotation of the rotor assembly 30 by the stator.

When comparing Examples 2 and 4, a similar correlation is observed. The difference between Examples 2 and 4 is the absence of a magnetic material other than the magnetic portions 174 in Example 2 versus the presence of bonded ferrite in addition to the magnetic portions in Example 4. The presence of the bonded ferrite in Example 4 tempered the shape of the magnetic field as a function of circumferential position about the body 34, similar to increasing the thickness of the polymer when comparing Examples 1 and 2 or increasing the thickness of the magnetic material when comparing Examples 3 and 4. The tempered shape of the plot for Example 4 when compared to Example 2 indicates a more stable magnetic field as a function of circumferential position about the body 34. Additionally, the change in magnetic field from zero degrees(0°) to forty-five degrees)(45° (i.e., a ΔB_{rad}) is greater for Example 4 than for Example 2. The increased ΔB_{rad} may be beneficial in providing a greater amount of torque to the shaft 38 during rotation of the rotor assembly 30 by the stator.

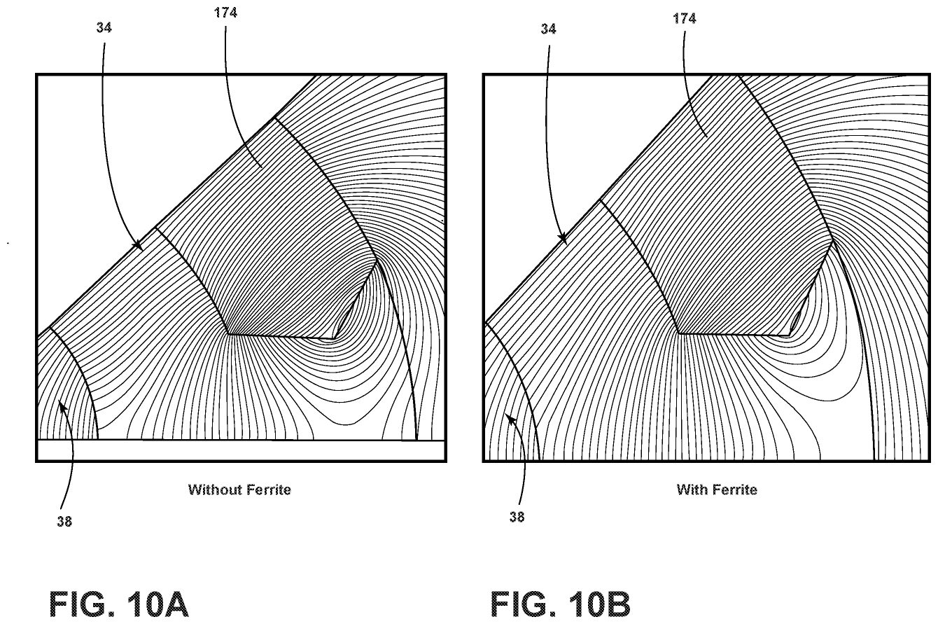

Referring to FIGS. 10A and 10B, magnetic field plots of examples of the body 34 made from a non-magnetic polymer (FIG. 10A) and the body 34 made from a polymer that included a magnetic material (FIG. 10B) are shown. The presence of the magnetic material within the polymer of the body 34, such as bonded ferrite, focused the magnetic field radially outward from the body 34 toward the stator. The magnetic field plots are depicted with one of the segmented body examples of the body 34. However, a similar focusing effect has been observed for the homogeneous body examples of the body 34. The body 34, the shaft 38, and one of the magnetic portions 174 are depicted.

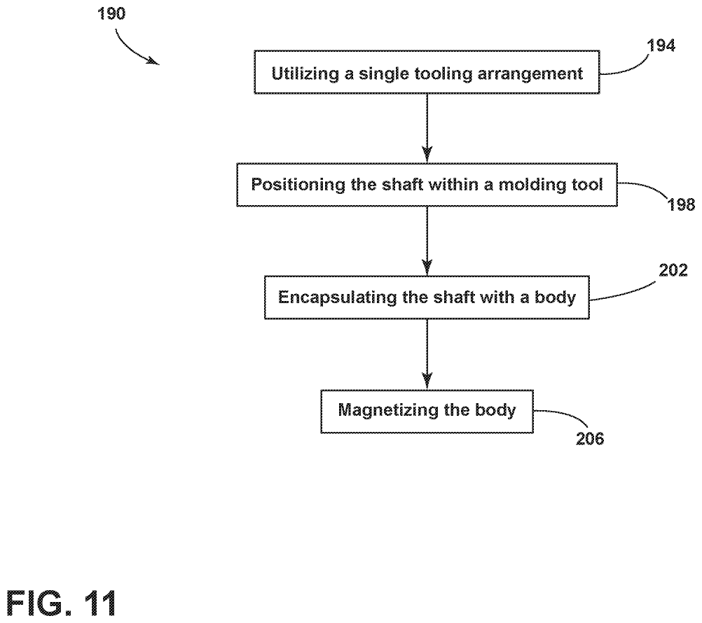

Referring now to FIG. 11, a method 190 of manufacturing the rotor assembly 30 includes step 194 of utilizing a single tooling arrangement, where the single tooling arrangement is provided with a plurality of inserts. The plurality of inserts can include individual inserts with varied lengths relative to one another. The method 190 also includes step 198 of positioning the shaft 38 within a molding tool. At step 202, the shaft 38 is encapsulated within the body 34 to form the rotor assembly 30. In various examples, the rotor assembly 30 includes magnetic particles. At step 206, the body 34 of the rotor assembly 30 can be magnetized.

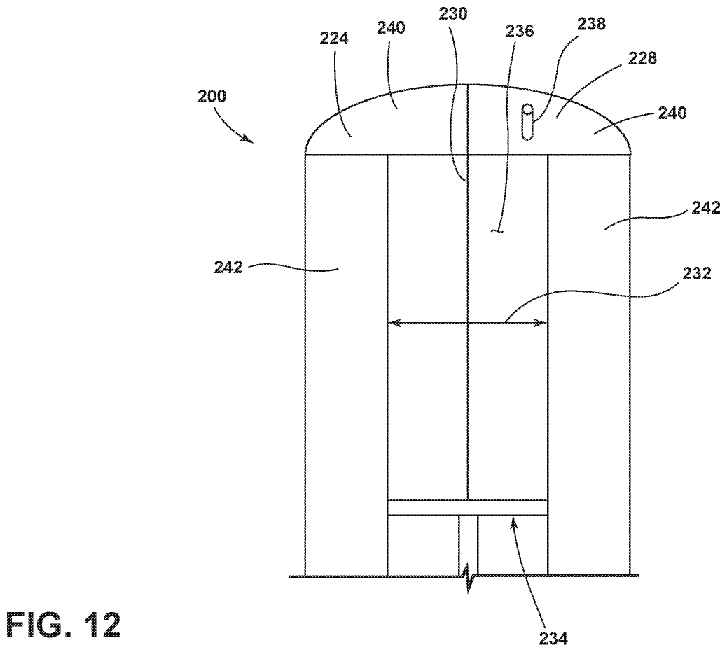

Referring to FIG. 12, a tooling arrangement 220 is shown in schematic cross-sectional form. The tooling arrangement 220 includes a first portion 224 and a second portion 228. The first portion 224 and the second portion are separate components and may come together such that a seam 230 is formed therebetween. The seam 230 may extend along a vertical axis, such as that depicted in FIG. 12. However, the present disclosure is not so limited. When the first and second portions 224, 228 are brought together, an inner diameter 232 is defined by the first and second portions 224, 228. The tooling arrangement 220 can also include a variable member 234. The variable member 234 is movable relative to the first and second portions 224, 228. For example, the variable member 234 may be movable or adjustable along a direction that is parallel to the seam 230. The first portion 224, the second portion 228, and the variable member 234 define a forming cavity 236 of the tooling arrangement 220. Accordingly, adjustment of a position of the variable member 234 relative to the first and second portions 224, 228 can adjust a volume of the forming cavity 236.

Referring again to FIG. 12, the position of the variable member 234 correlates to, or is generally related to, the length 54 of the body 34 of the rotor assembly 30 (see FIG. 1). The forming cavity 236 receives the material from which the body 34 of the rotor assembly 30 is to be made. In various examples, the inner diameter 232 of the first and second portions can be maintained as a constant dimension as the position of the variable member 234 is adjusted. In some examples, the tooling arrangement 220 includes one or more coils that are configured to orient magnetic poles of the body 34 of the rotor assembly 30. The coil(s) are electrically conductive. Upon providing an electrical current to the coil, a magnetic field can be induced within the tooling arrangement 220. In various examples, the tooling arrangement 200 can include pocket-forming inserts that are utilized to form the recesses 158 in the body 34. The recesses 158 may each receive one of the magnetic portions 174 after removal of the pocket-forming inserts. The tooling arrangement 220 can include an injection port 238. The injection port 238 may be positioned in a top wall 240 of the first portion 224 and/or the second portion 228. Additionally or alternatively, the injection port 238 may be positioned in a side wall 242 of the first portion 224 and/or the second portion 228.

In various examples, the shaft 38 can be overmolded with the body 34. The body 34 may be a monolithic body of magnetic polymer material. In an overmolded configuration of the shaft 38, a monolithic body of magnetic polymer particles, such as bonded neodymium iron boron (NdFeB), are disposed within an injection moldable matrix or a compression moldable matrix. The resulting product is a shaft 38 that is bonded with the magnetic polymer body 34. It is contemplated that the magnetic particles may be magnetic polymer particles and/or magnetic particles that are encased in a polymeric material. After assembly of the rotor assembly 30, which includes the shaft 38 and the magnetic polymer body 34, a magnetic field can be imposed on the rotor assembly 30 that is suitable for the stator to which the rotor assembly 30 is paired. In some examples, imposing a magnetic field upon the rotor assembly 30 after the molding process that assembles the rotor assembly 30 is complete can be impractical and may not be possible. For example, when the magnetic polymer material of the body 34 is a ferrite ceramic particulate in an injection moldable or a compression moldable polymer matrix, the resulting rotor assembly 30 cannot have a defined magnetic polar arrangement imposed after molding. In such examples, a coil, which is integrated into the molding tool utilized for the molding process, is energized during the molding process such that a defined magnetic polar arrangement is imposed during the molding process.

A benefit of the present disclosure is in the use of a single tooling arrangement to make and/or assemble multiple versions of the rotor assembly 30. The single tooling arrangement utilized is capable of use for making rotor assemblies 30 that include either bonded neodymium iron boron or an iron ceramic within a polymer matrix. The single tooling arrangement can be adjusted for length to manufacture a family of rotor assemblies 30 with decreased tooling costs.

Sintered neodymium has a significantly stronger magnetic attraction force than either of the injection or compression moldable bonded configurations of neodymium iron boron in a polymer matrix or iron ceramic in a polymer matrix. It may be beneficial to provide an injection moldable retention structure (e.g., the body) within the single tooling arrangement, thereby increasing the configurations of rotor assemblies 30 that can be manufactured with respect to varying the magnetic strength of the resultant rotor assembly 30 during the tooling/manufacturing process.

In various examples of the present disclosure, the single tooling arrangement can include pocket-forming inserts that are configured to create pockets (e.g., the recesses 158) within the body 34 that are designed to receive sintered neodymium magnets following the overmolding of the shaft 38. The pockets created by the pocket-forming inserts retain the sintered magnets, which are inserted in a direction that is parallel to the shaft 38. The sintered magnets are arranged such that adjacent magnets, when assembled in the body 34, have opposing polar arrangements. The rotor assembly 30, once assembled, is placed in magnetic communication with electromagnets of the stator (e.g., the plurality of windings).

In some examples of the present disclosure, the pockets created by the pocket-forming inserts may be magnetized during the manufacturing process. For example, the pockets may be magnetized during the molding process. In such an example, the body 34 may be molded of a polymer material that includes iron ceramic. Accordingly, with the body 34 magnetized in addition to the sintered magnets being present in the assembled rotor assembly 30, the body 34 both retains the sintered magnets in their desired position while also enhancing the magnetic performance of the rotor assembly 30.

In the various examples and variations discussed herein, a family of rotor assemblies 30 can be created by utilizing a single tooling arrangement. The family of rotor assemblies 30 can be manufactured with varying magnetic properties, varying lengths, and/or varying other dimensions. By utilizing the single tooling arrangement, a number of tooling inserts and a number of post-production modification operations can be decreased. The single tooling arrangement can be utilized to magnetize a ferrite ceramic bonded rotor assembly within the tooling arrangement, utilized to manufacture a neodymium iron boron bonded rotor assembly within the tooling arrangement without magnetizing the body 34, or can be utilized to magnetize a ferrite ceramic bonded retention structure (e.g., body 34) that receives sintered magnetic sections (e.g., magnetic portions 174). The magnetized ferrite ceramic bonded retention structure additionally serves to enhance the overall performance of the sintered neodymium magnet within the rotor assembly 30.

Permanent magnetic rotors, such as those disclosed herein, are used in a variety of permanent magnet machines and/or instruments. The present disclosure provides a modular design for magnetic rotor assemblies 30 that can be produced from a common core tool, which may include inserts such as the magnetic portions 174, to achieve a family of rotor assemblies 30 that can be varied according to cost, size, and/or performance tradeoffs. In various examples, the rotor assembly 30 may maintain a common diameter, in which case the rotor assembly 30 can be manufactured and/or assembled in various lengths by changing the body 34, the shaft 38, and/or the magnetic portions 174 to correspond with a desired length and/or magnetic field.

Bonded ferrite magnets are often referred to as magnetic iron ceramic particles bonded in a polymer matrix and are typically produced as an injection or compression moldable material. Ferrite bonded magnets are magnetized within the tool that is used to assemble the rotor assembly 30, thus a tool with integrated magnetic coils in the core is contemplated, whereby the ferrite material can be injection molded and magnetized while still in the tool to impose a specific magnetic pole arrangement on the rotor assembly 30. Ferrite magnets are a low cost magnet material and have a low flux density when compared to bonded neodymium and sintered neodymium.

Bonded neodymium iron boron (NdFeB) magnets are often referred to as magnetic neodymium iron boron particles bonded in a polymer matrix produced as an injection moldable material. Neodymium iron boron bonded magnets do not need to be magnetized in the tool during molding and can be ejected without a significant magnetic field imposed on the rotor assembly 30. Once ejected, the rotor assembly 30 can be post-mold magnetized to impose a specific magnetic pole arrangement on the rotor assembly 30 that corresponds to the electromagnetic poles of the stator with which the rotor assembly 30 is paired. While the tool has the capability of magnetizing the rotor assembly 30 within the tool, since the tooling and integrated magnetizing coil is common to the bonded ferrite version, it is up to various factors that are under consideration, such as the application, logistics, and cost, as to whether or not the magnet would be magnetized within the tool. Neodymium iron boron magnets are more costly than bonded ferrite magnets and less costly than sintered neodymium magnets. Neodymium iron boron magnets have a higher magnetic flux density than bonded ferrite but less magnetic flux density than sintered neodymium magnets.

With the homogeneous body examples of the body 34, a number of configurations are possible for the magnetic sections or regions. For example, the number of magnetic sections can be greater than 2, greater than 3, greater than 4, greater than 5, greater than 6, and so on. Additionally or alternatively, the magnetic sections may be made wider, narrower, or may taper from one end to another. In some examples, the magnetic sections within the body 34 may be varied as a function of circumferential position about the body 34. In various examples, the polarity of the magnetic sections may vary as a function of position along the length 54 of the body 34. For example, the polarity along a given lengthwise cross-section of the body 34 may be offset such that as the length 54 is traversed, the polarity of the body 34 reaches an inflection point or change in directionality of the polarity.

With an additional insert in the tooling, such as the magnetic portions 174, the recesses 158 can be molded to hold the magnetic portions 174, which may be sintered neodymium iron boron magnet segments. While the depicted examples of the segmented body show four recesses 158 that each receive one of the magnetic portions 174, one of skill in the art will recognize that greater or fewer recesses 158 and corresponding magnetic portions 174 may be utilized without departing from the concepts disclosed herein. In the segmented body examples, the polymer that is utilized in the manufacture of the rotor assembly 30 is not required to be a bonded ferrite or bonded neodymium injection molding compound and can simply be a standard grade polymer, filled or unfilled. The magnetizing coils that were integrated into the tooling would not be energized during molding of a standard polymer compound. Standard polymers do not have any magnetic properties and the magnetic flux available is limited to that of the magnet segments, such as the magnetic portions 174, and their proximity to the electromagnetic cores of the associated stator. There is no magnetic flux path radially inward from the magnetic portions 174, which may be sintered segments. Sintered neodymium has the highest magnetic flux density when compared to bonded ferrite or bonded neodymium. However, sintered neodymium is also the most expensive when compared to the bonded ferrite and bonded neodymium. An injection moldable bonded ferrite can be used in place of the polymer and may provide an optimized magnetic flux path. In this case, a ferrite-impregnated body 34 is molded from the bonded ferrite injection moldable material and magnetized with the magnetizing coil in the tool to impose a desired magnetic field. When the sintered magnet segments, such as the magnetic portions 174, are placed into the bonded ferrite body 34 after molding, the bonded ferrite body 34 provides an improvement in magnetic performance versus the sintered segments in a polymer only body 34 as the bonded ferrite body 34 enhances the field strength of the rotor assembly 30.

Modifications of the disclosure will occur to those skilled in the art and to those who make or use the concepts disclosed herein. Therefore, it is understood that the embodiments shown in the drawings and described above are merely for illustrative purposes and not intended to limit the scope of the disclosure.

It will be understood by one having ordinary skill in the art that construction of the described concepts, and other components, is not limited to any specific material. Other exemplary embodiments of the concepts disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise.

1-26. (canceled)

27. A rotor assembly for use with a stator, the rotor assembly comprising:
a shaft that defines at least one outer diameter; and
a body that defines at least one interior diameter, the shaft being received within the at least one interior diameter of the body, wherein the body is provided with a magnetic field with alternating polar arrangements as a function of a circumferential position about a circumference of the body, wherein the body is made of a polymeric material, wherein the polymeric material comprises magnetic particles, and wherein an exterior surface of the body is continuous such that a boundary between adjacent magnetic sections of the body are imperceptible to a human eye.

28. The rotor assembly of claim 27, wherein the body is overmolded upon the shaft.

29. The rotor assembly of claim 27, wherein the body is produced in a monolithic form such that the body encapsulates the shaft.

30. The rotor assembly of claim 27, wherein the magnetic particles comprise bonded neodymium iron boron.

31. The rotor assembly of claim 27, wherein the magnetic particles are magnetic polymer particles.

32. The rotor assembly of claim 27, wherein the magnetic particles are utilized to impose magnetic poles to the body.

33. A rotor assembly for use with a stator, the rotor assembly comprising:
a shaft that defines at least one outer diameter; and
a body, wherein the body comprises:
at least one interior diameter defined by the body, the shaft being received within the at least one interior diameter of the body;
a polymeric material from which the body is made, wherein the polymeric material comprises magnetic particles;
a plurality of first protrusions; and
a plurality of second protrusions positioned between adjacent ones of the plurality of first protrusions, wherein the first and second protrusions define recesses therebetween.

34. The rotor assembly of claim 33, wherein the body further comprises:
a plurality of magnetic portions, wherein each of the recesses receives one of the plurality of magnetic portions.

35. The rotor assembly of claim 33, wherein the body is provided with a magnetic field with alternating polar arrangements as a function of a circumferential position about a circumference of the body.

36. The rotor assembly of claim 35, wherein the plurality of magnetic portions are sintered neodymium magnets.

37. A tooling arrangement, comprising:
a first portion;
a second portion, wherein the first and second portions define an inner diameter; and
a variable member, wherein the first portion, the second portion, and the variable member define a forming cavity, wherein the variable member is movable with respect to the first portion and the second portion such that a volume of the forming cavity is adjustable, and wherein the forming cavity is configured to receive a magnetic material.

38. The tooling arrangement of claim 37, wherein the forming cavity receives a polymeric material.

39. The tooling arrangement of claim 38, wherein the polymeric material defines at least a portion of a body of a rotor assembly.

40. The tooling arrangement of claim 37, wherein the volume of the forming cavity is adjusted by altering a position of the variable member with respect to the first and second portions.

41. The tooling arrangement of claim 40, wherein the position of the variable member correlates to a length dimension of the body of the rotor assembly.

42. The tooling arrangement of claim 37, wherein the inner diameter of the first and second portions are maintained as a constant dimension as the position of the variable member is adjusted.

43. The tooling arrangement of claim 38, wherein the polymeric material comprises magnetic particles.

44. The tooling arrangement of claim 39, further comprising:
a coil that is configured to orient magnetic poles of the body of the rotor assembly.

45. The tooling arrangement of claim 38, further comprising:
pocket-forming inserts that are utilized to form recesses in the body.

46. The tooling arrangement of claim 45, wherein the recesses each receive a magnetic portion after removal of the pocket-forming inserts.
